(19) United States
(12) Patent Application Publication
(10) Pub. No.: US 2016/0011662 A1
(43) Pub. Date: Jan. 14, 2016

(54) ELECTRONIC DEVICE, METHOD, AND COMPUTER PROGRAM PRODUCT

(71) Applicant: KABUSHIKI KAISHA TOSHIBA, Tokyo (JP)

(72) Inventors: Akira TANAKA, Mitaka Tokyo (JP); Kouichi OGI, Hanno Saitama (JP)

(21) Appl. No.: 14/567,186

(22) Filed: Dec. 11, 2014

(30) Foreign Application Priority Data
Jul. 8, 2014 (JP) 2014-140874

(51) Int. Cl. G06F 3/01; G09G 5/00; G06T 1/20

(52) U.S. Cl. CPC G06F 3/014; G06T 1/20; G09G 5/003; G09G 2370/16

(57) ABSTRACT

An electronic device including: a communication device; and circuitry configured to receive a first instruction for changing a mode of the electronic device to a first mode, configured to transmit by using the communication device to an external device a second instruction for changing a mode of the external device to a second mode corresponding to the first mode, and configured to change a mode of the electronic device to the first mode.

### CROSS-REFERENCE TO RELATED APPLICATIONS

This application is based upon and claims the benefit of priority from Japanese Patent Application No. 2014-140874, filed Jul. 8, 2014, the entire contents of which are incorporated herein by reference.

### FIELD

Embodiments described herein relate generally to an electronic device, a method, and a computer program product.

### BACKGROUND

An electronic device such as a wearable device has a variety of modes including an airplane mode which prohibits wireless communication with an external device (such as a smartphone, a tablet terminal, or a laptop PC (Personal Computer)), and a silent mode which prohibits a speaker from outputting sound.

It is inconvenient that the wearable device and the external device need to be operated separately to change a mode of the wearable device and the external device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram illustrating a configuration of a communication system provided with an electronic device according to the present embodiment;

FIG. 2 is a block diagram illustrating a hardware configuration of a wearable device according to the present embodiment;

FIG. 3 is a block diagram illustrating a functional configuration of the wearable device according to the present embodiment;

FIG. 4 is a flowchart illustrating a flow of a mode changing process performed in the wearable device according to the present embodiment;

FIG. 5 is a diagram illustrating for explaining the mode changing process performed in the communication system according to the present embodiment; and

FIG. 6 is a diagram illustrating for explaining another example of the mode changing process performed in the communication system according to the present embodiment.

### DETAILED DESCRIPTION

In general, according to one embodiment, a communication device; and circuitry configured to receive a first instruction for changing a mode of the electronic device to a first mode, configured to transmit by using the communication device to an external device a second instruction for changing a mode of the external device to a second mode corresponding to the first mode, and configured to change a mode of the electronic device to the first mode.

An electronic device, a method, and a computer program product according to the present embodiment will be described below with reference to the drawings.

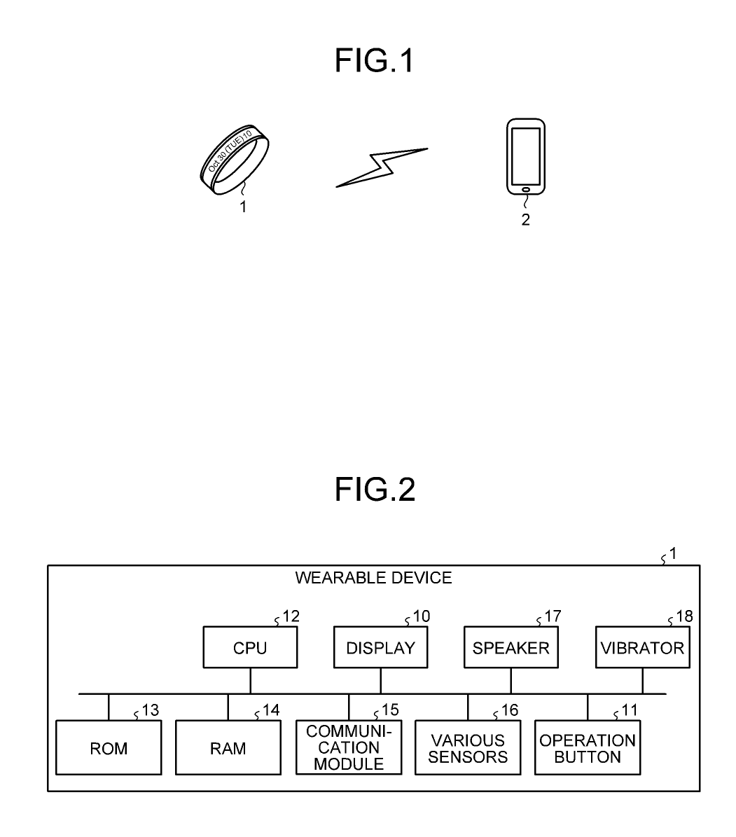

FIG. 1 is a diagram illustrating a configuration of a communication system provided with the electronic device according to the present embodiment. As illustrated in FIG. 1, the communication system according to the present embodiment includes a wearable device 1 (which is an example of the electronic device, for example, a wearable device of a wristwatch type or ring type) which can detect biological information (such as an amount of activity including the number of steps and calorie consumption, body temperature, perspiration, and pulse) of a user and can be worn on a part of the body of the user, and a host device 2 (which is an example of an external device, for example, a smartphone, a tablet terminal, or a laptop PC) which can perform communication with the wearable device 1.

In the present embodiment, the wearable device 1 and the host device 2 include a function to perform wireless communication via Bluetooth (registered trademark). In the present embodiment, the wearable device 1 and the host device 2 are already paired and thus automatically become ready for two-way wireless communication when the both devices are within a service area.

FIG. 2 is a block diagram illustrating a hardware configuration of the wearable device according to the present embodiment. As illustrated in FIG. 2, the wearable device 1 according to the present embodiment includes a display 10, an operation button 11, a central processing unit (CPU) 12, a read only memory (ROM) 13, a random access memory (RAM) 14, a communication module 15, various sensors 16, and the like.

The display 10 formed of an liquid crystal display (LCD) and the like is a display module which can display various pieces of information such as a message notifying of receiving an e-mail and/or a phone call on the host device 2 and a detection result of the biological information. The display 10 may also be a touch panel display which can detect the position of a touch operation performed on the display 10.

The operation button 11 is an operation module which can input various operations to the wearable device 1. A speaker 17 outputs a sound notifying of such as receiving the e-mail and/or the phone call on the host device 2, a sound notifying of the detection result of the biological information, or the like. A vibrator 18 vibrates the wearable device 1 and notifies the user of such as receiving the e-mail and/or the phone call on the host device 2.

The CPU 12 is an example of a processor (or a computer) which controls each module included in the wearable device 1. The CPU 12 uses the RAM 14 as a work area to execute various programs stored in the ROM 13 and controls each module included in the wearable device 1. The various programs stored in the ROM 13 include a mode changing program used to execute a mode changing process on the wearable device 1.

The communication module 15 is an example of a communication device used to communicate with the external device such as the host device 2. While there is described in the present embodiment the example where the communication module 15 communicates with the host device 2 via Bluetooth (registered trademark), the embodiment is not limited to this and the module may also be adapted to communicate with the external device via wireless fidelity (WiFi) or wired connection.

The various sensors 16 include an illuminance sensor, an acceleration sensor, a gyro sensor, a temperature sensor, a humidity sensor and the like. Here, the illuminance sensor included in the various sensors 16 can detect brightness around the wearable device 1. The acceleration sensor included in the sensors 16 can detect acceleration of the wearable device 1. The gyro sensor included in the sensors 16 can detect an angle or angular velocity of the wearable device 1. The humidity sensor included in the sensors 16 can detect humidity around the wearable device 1. The temperature sensor included in the sensors 16 can detect temperature around the wearable device 1.

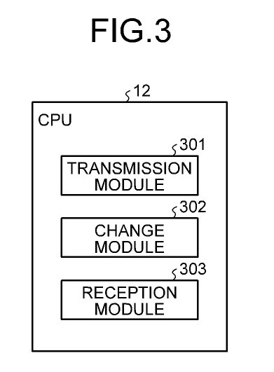

FIG. 3 is a block diagram illustrating a functional configuration of the wearable device according to the present embodiment. In the present embodiment, the CPU 12 reads out the mode changing program from the ROM 13, executes the program, and generates a transmission module 301, a change module 302, and a reception module 303 on the RAM 14.

When there is input a mode changing operation (an example of a first instruction) giving an instruction to change the mode of the wearable device 1 to any mode (hereinafter referred to as a first mode) out of modes included in the wearable device 1, the transmission module 301 uses the communication module 15 to transmit, to the host device 2, a mode changing instruction (an example of a second instruction) to change the mode to a mode (hereinafter referred to as a second mode) corresponding to the first mode. The change module 302 executes the process of changing the mode of the wearable device 1 to the first mode when the mode changing operation is input. The reception module 303 receives from the host device 2 a change completion notification (an example of a first notification) by which completion of the change of mode to the second mode is recognizable.

A program executed on the wearable device 1 of the present embodiment is provided while being included in advance in the ROM 13 or the like, but it is not limited to such case. For example, the program executed on the wearable device 1 of the present embodiment may be provided while being recorded in a recording medium that can be read by a computer in a file having an installable or executable format, the recording medium including such as a CD-ROM, a flexible disk (FD), a CD-R, and a digital versatile disk (DVD).

Moreover, the program executed on the wearable device 1 of the present embodiment may be stored on a computer connected to a network such as the Internet and provided by causing the computer to download the program via the network. The program executed on the wearable device 1 of the present embodiment may also be provided or distributed via the network such as the Internet.

While the single CPU 12 included in the wearable device 1 executes the mode changing program to realize the transmission module 301, the change module 302, and the reception module 303 in the present embodiment, the embodiment is not limited to this. A plurality of computers (such as the CPU 12 included in the wearable device 1 and a CPU included in the external device) may instead execute the mode changing program to realize the transmission module 301, the change module 302, and the reception module 303 as well.

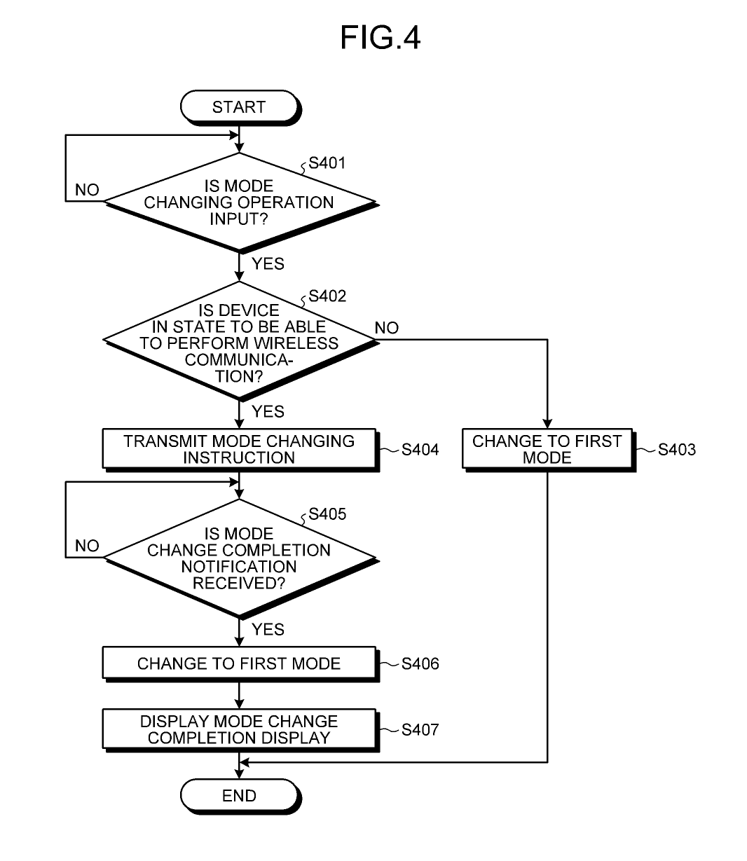

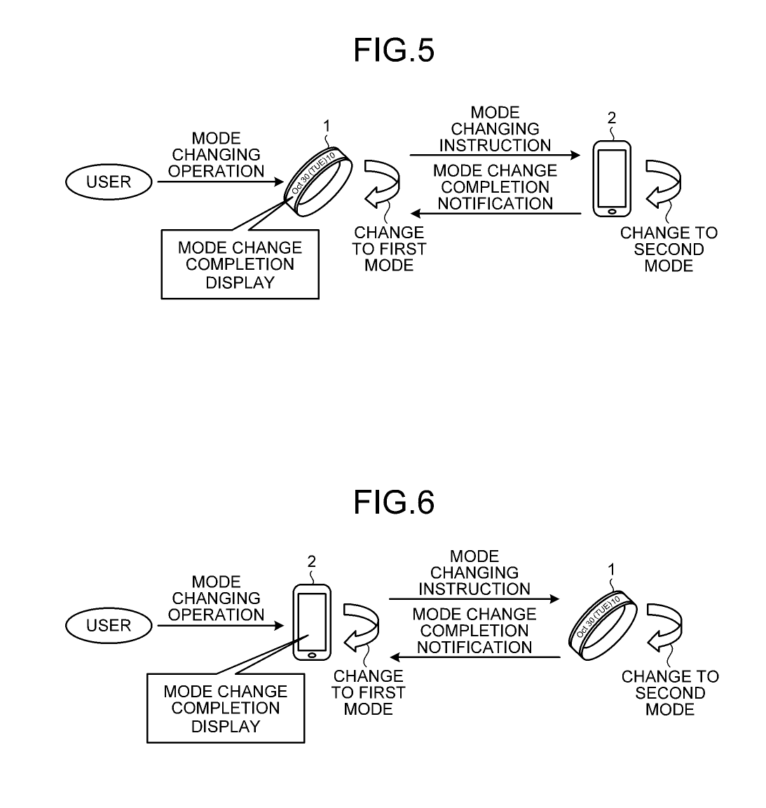

Next, there will be described the mode changing process performed in the wearable device 1 according to the present embodiment with reference to FIGS. 3 to 5. FIG. 4 is a flowchart illustrating a flow of the mode changing process performed in the wearable device according to the present embodiment. FIG. 5 is a diagram illustrating for explaining the mode changing process performed in the communication system according to the present embodiment.

As illustrated in FIGS. 4 and 5, the transmission module 301 and the change module 302 wait for the mode changing operation to be input by use of the operation button 11 or the like (step S401). The mode changing operation is an operation to give an instruction to change the mode of the wearable device 1 to the first mode that is any one of modes (such as an airplane mode and a silent mode) included in the wearable device 1. Here, the airplane mode is a mode in which a function prohibiting the wireless communication is executed. The silent mode is a mode in which a function prohibiting the speaker 17 from outputting a sound is executed.

When the mode changing operation is input by use of the operation button 11 or the like (step S401: Yes), the transmission module 301 determines whether or not the device is in a state to be able to perform the wireless communication with the host device 2, the mode of which is changed when the mode of the wearable device 1 is changed, as illustrated in FIGS. 4 and 5 (step S402). In the present embodiment, the transmission module 301 uses the communication module 15 to determine whether or not the device is in the state to be able to perform the wireless communication with the host device 2 via Bluetooth (registered trademark). The transmission module 301 determines whether or not the device is in the state to be able to perform the wireless communication with the host device 2 in the present embodiment but, when the wearable device 1 is in the wired connection with the host device 2, determines whether or not the device can communicate with the host device 2 via wired connection.

When it is determined that the device is not in the state to be able to perform the wireless communication with the host device 2 (step S402: No), the change module 302 executes the process of changing the mode of the wearable device 1 to the first mode instructed by the mode changing operation that is input (step S403).

Specifically, when the first mode instructed by the input mode changing operation is the airplane mode, the change module 302 changes the mode of the wearable device 1 to the airplane mode by controlling the communication module 15 and executing the function that prohibits the wireless communication. When the first mode instructed by the input mode changing operation is the silent mode, the change module 302 changes the mode of the wearable device 1 to the silent mode by executing the function that prohibits the speaker 17 from outputting a sound and the function that prohibits the vibrator 18 from vibrating.

After changing the mode to the first mode instructed by the input mode changing operation, the change module 302 in the present embodiment maintains the first mode until an instruction is given by the operation button 11 or the like to cancel the first mode or until a new mode changing operation is input, but the first mode may be canceled automatically depending on the type of the first mode. When the first mode instructed by the input mode changing operation is a mode (such as the airplane mode) that executes the function prohibiting the wireless communication with the external device, for example, the change module 302 cancels the first mode when atmospheric pressure detected by an atmospheric pressure sensor included in the various sensors 16 is returned to ground atmospheric pressure, a current position received by a global positioning system (GPS) receiver included in the wearable device 1 indicates at a predetermined destination, or a predetermined time has elapsed after the mode is changed to the airplane mode, for example.

When it is determined that the device is in the state to be able to perform the wireless communication with the host device 2 (step S402: Yes), on the other hand, the transmission module 301 uses the communication module 15 to transmit to the host device 2 a mode changing instruction to change the mode to the second mode corresponding to the first mode that is instructed by the input mode changing operation prior to changing the mode to the first mode instructed by the input mode changing operation, as illustrated in FIGS. 4 and 5 (step S404). This prevents the case, when the first mode is the airplane mode, that the mode of the wearable device 1 is changed to the airplane mode prior to transmitting the mode changing instruction, prohibiting the device from performing the wireless communication with the host device 2 and that the mode changing instruction can't be transmitted to the host device 2.

In the present embodiment, the mode changing instruction is transmitted prior to changing the mode of the wearable device 1 to the first mode regardless of whether or not the first mode is the mode (such as the airplane mode) which executes the function prohibiting the wireless communication. It may however be adapted to transmit the mode changing instruction prior to changing the mode of the wearable device 1 to the first mode at least when the first mode is the mode which executes the function prohibiting the wireless communication. Therefore, when the first mode is a mode (such as the silent mode) which continues the wireless communication with the external device, the change module 302 may transmit the mode changing instruction to the host device 2 after changing the mode of the wearable device 1 to the first mode.

Moreover, when it is determined that the device is in the state to be able to perform the wireless communication with the host device 2, the transmission module 301 in the present embodiment transmits the mode changing instruction to the host device 2 regardless of the intention of the user who uses the wearable device 1, but it is not limited to such case. The transmission module 301 may transmit the mode changing instruction to the host device 2 when, for example, the user selects (gives an instruction) to change the mode of the host device 2 through the operation button 11 or the like, or when it is preset to change the mode of the host device 2. On the other hand, the transmission module 301 may be adapted to not transmit the mode changing instruction to the host device 2 when the user does not select (does not give an instruction) to change the mode of the host device 2 through the operation button 11 or the like, or when it is not preset to change the mode of the host device 2.

Moreover, the mode changing instruction is an instruction given to execute a function similar to the function executed when the mode of the wearable device 1 is changed to the first mode. When the host device 2 is the external device (such as the smartphone or the tablet terminal) having the same mode as the first mode (such as the airplane mode and the silent mode), for example, the transmission module 301 transmits to the host device 2 a mode changing instruction (such as an instruction to prohibit the host device 2 from performing the wireless communication or an instruction to cause the host device 2 to lower or mute the volume) which the second mode is instructed as the same mode as the first mode. When the host device 2 is a device (such as the laptop PC) not having the same mode as the first mode (such as the airplane mode and the silent mode), on the other hand, the transmission module 301 transmits to the host device 2 a mode changing instruction which instructs, as the second mode, a mode which executes a function (such as a function to lower or mute the volume) similar to the function executed when the mode is changed to the first mode (such as the silent mode).

In the present embodiment, the transmission module 301 transmits to the host device 2 the mode changing instruction to execute the function that is similar to the function executed when the mode is changed to the first mode, but the transmission module is not limited to perform what is described above. Specifically, when a mode executing a function (such as a function allowing a sound to be output) different from the function (such as the function to lower or mute the volume) executed in the first mode is preset as a mode corresponding to the first mode, the transmission module 301 may transmit to the host device 2 a mode changing instruction which instructs, as the second mode, a mode executing a function different from the function executed in the first mode.

The transmission module 301 may also change the second mode according to the host device 2 to which the mode changing instruction is transmitted. When the first mode which is instructed by the mode changing operation is a mode (such as the silent mode) giving the instruction to perform the function that prohibits the wearable device 1 from outputting a sound to the surroundings and when the host device 2 is a device (such as a portable music player) which outputs sound to an earphone, for example, the function prohibiting the host device 2 from outputting sound to the surroundings is realized on the host device 2 without lowering the volume of the sound output from the earphone. In this case, the transmission module 301 transmits to the host device 2 a mode changing instruction which instructs, as the second mode, a mode giving the instruction to execute a function (such as turning off the vibrator), other than the function which prohibits the host device 2 from outputting sound to the surroundings, from among the functions executed when the mode is changed to the silent mode.

When the first mode which is instructed by the mode changing operation is a mode giving the instruction to perform the function that lowers the volume of the sound output from the speaker 17 and when the host device 2 is the laptop PC, for example, the sound output from a speaker of the host device 2 presumably affects the surroundings more than the sound output from the wearable device 1 does. In this case, the transmission module 301 transmits to the host device 2 a mode changing instruction which instructs, as the second mode, a mode giving the instruction to execute a function that lowers the volume more than the volume lowered by the function that is executed when the mode is changed to the first mode.

As illustrated in FIG. 5, the host device 2 receives the mode changing instruction transmitted from the transmission module 301 of the wearable device 1 and thereafter executes the process of changing the mode to the second mode instructed by the mode changing instruction. As a result, the user can change the mode of the host device 2 to a desired mode by changing the mode of the wearable device 1 to the desired mode even when he cannot directly operate the host device 2 that is put away in a bag or the like at the start of a meeting or at the time of boarding an airplane, so that the user need not take the host device 2 out of the bag or the like and directly operate the device to change the mode of the host device 2, thereby improving the convenience. After changing the mode to the second mode, the host device 2 transmits to the wearable device 1 a mode change completion notification (an example of the first notification), by which completion of the change of mode to the second mode is recognizable, via wireless communication as illustrated in FIG. 5.

After the mode changing instruction is transmitted to the host device 2 by the transmission module 301, the reception module 303 receives the mode change completion notification (an example of the first notification), by which completion of the change of mode to the second mode is recognizable, from the host device 2 via the wireless communication with use of the communication module 15, as illustrated in FIGS. 4 and 5. The change module 302 determines whether or not the mode change completion notification is received by the reception module 303 (step S405). After the mode change completion notification is received from the host device 2 via the wireless communication (step S405: Yes), the change module 302 executes the process of changing the mode of the wearable device 1 to the first mode (step S406). This prevents the case, when the first mode is the airplane mode, that the mode of the wearable device 1 is changed to the airplane mode before receiving the mode change completion notification, and that the device is not able to perform the wireless communication with the host device 2 and to receive the mode change completion notification.

In the present embodiment, the process of changing the mode of the wearable device 1 to the first mode is executed after the mode change completion notification is received by the reception module 303, regardless of whether or not the first mode is the mode (such as the airplane mode) which prohibits the wireless communication. It may however be adapted to execute the process of changing the mode of the wearable device 1 to the first mode after receiving the mode change completion notification by the reception module 303, at least when the first mode is the mode in which the function prohibiting the wireless communication is executed. Therefore, when the first mode is the mode (such as the silent mode) which continues the wireless communication with the external device, the change module 302 may change the mode of the wearable device 1 to the first mode before receiving the mode change completion notification.

When the mode change completion notification is received by the reception module 303, the change module 302 causes the display 10 to provide a display for notifying that the mode of the host device 2 is changed (hereinafter referred to as a mode change completion display) (step S407). While the change module 302 in the present embodiment causes the display 10 to display the mode change completion display after receiving the mode change completion notification from the host device 2, the embodiment is not limited to this as long as the user is notified of the completion of the change in mode of the host device 2. The user may be notified of the completion of the change in mode of the host device 2 by another method such as by vibrating the wearable device 1 with the vibrator 18, for example.

According to the wearable device 1 of the present embodiment, the user need not take the host device 2 out of the bag or the like and directly operate the device to change the mode of the host device 2, thereby improving the convenience.

There has been described the process of changing the mode of the host device 2 (an example of the external device) following the change in mode of the wearable device 1 performed in response to the mode changing operation that is input to the wearable device 1 (an example of the electronic device). When the mode changing operation is input to the host device 2 (an example of the electronic device) as well, the process of changing the mode of the wearable device 1 (an example of the external device) can be executed following the change in mode of the host device 2 as with the mode changing process performed on the wearable device 1.

As a result, the mode of both the wearable device 1 and the host device 2 can be changed as long as the mode changing operation is input to either the wearable device 1 or the host device 2, so that the mode changing operation need not be input to both the wearable device 1 and the host device 2 and that the convenience can be improved.

Now, FIG. 6 will be used to briefly describe the process of changing the mode of both the host device 2 and the wearable device 1 when the mode changing operation is input to the host device 2. FIG. 6 is a diagram illustrating for explaining another example of the mode changing process performed in the communication system according to the present embodiment.

When there is input the mode changing operation giving the instruction to change the mode of the host device 2 to the first mode out of the modes included in the host device 2, as illustrated in FIG. 6, the host device 2 transmits to the wearable device 1 the mode changing instruction to change the mode to the second mode via the wireless communication prior to changing the mode to the first mode that is instructed by the input mode changing operation.

As illustrated in FIG. 6, the wearable device 1 receives the mode changing instruction transmitted from the host device 2 and thereafter executes the process of changing the mode to the second mode instructed by the mode changing instruction. After changing the mode to the second mode, the wearable device 1 transmits to the host device 2 the mode change completion notification, by which completion of the change of mode to the second mode is recognizable, via the wireless communication as illustrated in FIG. 6.

After receiving the mode change completion notification from the wearable device 1, the host device 2 executes the process of changing the mode to the first mode that is instructed by the input mode changing operation, as illustrated in FIG. 6. Upon receiving the mode change completion notification, the host device 2 further causes the display included in the host device 2 to display the mode change completion display for notifying that the mode of the wearable device 1 is changed, as illustrated in FIG. 6.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a communication device; and
circuitry configured to receive a first instruction for changing a mode of the electronic device to a first mode, configured to transmit by using the communication device to an external device a second instruction for changing a mode of the external device to a second mode corresponding to the first mode, and configured to change a mode of the electronic device to the first mode.

2. The electronic device according to claim 1, wherein the first mode of the electronic device is substantially same with the second mode of the external device.

3. The electronic device according to claim 2, wherein the second instruction is to prohibit the external device from wireless communication when the first mode is a mode of prohibiting the wireless communication.

4. The electronic device according to claim 1, wherein the circuitry is further configured to:
receive the first instruction from an input operation;
transmit the second instruction to the external device;
receiving a notification of completion of changing the mode to the second mode from the external device; and
change the mode of the electronic device to the first mode.

5. The electronic device according to claim 2, further comprising a speaker, wherein
the second instruction is to lower or mute volume of sound output from the external device when the first mode is a mode of prohibiting the speaker from outputting sound.

6. A method for controlling an electronic device capable of communicating with an external device, the method comprising,
receiving a first instruction for changing a mode of the electronic device to a first mode,
transmitting to an external device a second instruction for changing a mode of the external device to a second mode corresponding to the first mode; and
changing a mode of the electronic device to the first mode.

7. The method of claim 6, wherein the first mode of the electronic device is substantially same with the second mode of the external device.

8. The method of claim 7, wherein the second instruction is to prohibit the external device from wireless communication when the first mode is a mode of prohibiting the wireless communication.

9. The method of claim 6, further comprising:
receiving the first instruction from an input operation,
transmitting the second instruction to the external device,
receiving a notification of completion of changing the mode to the second mode from the external device; and
changing the mode of the electronic device to the first mode.

10. The method of claim 7, wherein the second instruction is to lower or mute volume of sound output from the external device when the first mode is a mode of prohibiting outputting sound.

11. A computer program product having a non-transitory computer medium including programmed instructions for an electronic device capable of communication with an external device, wherein the instructions, when executed by a computer, cause the computer to:
receive a first instruction for changing a mode of the electronic device to a first mode,
transmit to an external device a second instruction for changing a mode of the external device to a second mode corresponding to the first mode; and
change a mode of the electronic device to the first mode.

12. The computer program product of claim 11, wherein the first mode of the electronic device is substantially same with the second mode of the external device.

13. The computer program product of claim 12, wherein the second instruction is to prohibit the external device from wireless communication when the first mode is a mode of prohibiting the wireless communication.

14. The computer program product of claim 11, further comprises to:
receive the first instruction from an input operation;
transmit the second instruction to the external device;
receive a notification of completion of changing the mode to the second mode from the external device; and
change the mode of the electronic device to the first mode.

15. The computer program product of claim 12, wherein the second instruction is to lower or mute volume of sound output from the external device when the first mode is a mode of prohibiting outputting sound.
